(19) United States
(12) Patent Application Publication
(10) Pub. No.: US 2017/0010698 A1
(43) Pub. Date: Jan. 12, 2017

(54) SELFIE CAMERA AND WRITING DEVICE

(71) Applicants: Svetlana Ibragimova, Boston, MA (US); Aleksei Smetannikov, Cambridge, MA (US)

(72) Inventors: Svetlana Ibragimova, Boston, MA (US); Aleksei Smetannikov, Cambridge, MA (US)

(21) Appl. No.: 14/796,431

(22) Filed: Jul. 10, 2015

(51) Int. Cl. G06F 3/0354; H04N 1/00; F16C 11/04; G06F 17/30; B43K 29/08; H04N 5/225; G09G 3/34

(52) U.S. Cl. CPC G06F 3/03545; H04N 5/225; H04N 1/00183; H04N 5/2252; G09G 3/3406; G06F 17/30861; B43K 29/08; F16C 11/04

(57) ABSTRACT

A device for capturing “selfie” images is integrated into a writing device. The device includes an extendable (e.g., telescopic) section, such that when refracted the device is useful as a writing instrument (e.g., a pen, stylus, etc.), and when extended, provides a way of capturing selfie images, or other images that benefit from a point of view that is removed from the user beyond the user's reach. Advantages of one or more embodiments of the device include low cost, in some cases through the use of an optical trigger rather than more complex radio frequency (e.g., Bluetooth) transmission. Other advantages can include portability as a result of the device being integrated into a writing device, which is more compact than a smartphone

### BACKGROUND

The invention relates to a combination of a camera and writing device, for instance, taking portraits.

Partly through the availability of smartphones with integrated cameras, and partly through the popularity of social media, a trend has been the taking of “selfie” images by a user, typically with the user and other individuals, a landmark or other distinctive scene in the image, for example, in the form or a portrait. The use of a smartphone alone requires that the user extends his or her arm holding the smartphone pointed toward the subjects to be captured in the image. To overcome the difficulty in capturing an image at arm's length, a variety of extension arms have become available that permit mounting the smartphone at one end and providing a handhold at the other end. One way of triggering the camera is to include a Bluetooth transmitter at the handhold end and using software in the smartphone to receive a trigger signal from the transmitter to cause the smartphone to capture the image.

There is a need for a less expensive less cumbersome approach for individuals to capture “selfie” images.

### SUMMARY

In a general aspect, a device for capturing “selfie” images is integrated into a writing device. The device includes an extendable (e.g., telescopic) section, such that when retracted the device is useful as a writing instrument (e.g., a pen, stylus, etc.), and when extended, provides a way of capturing selfie images, or other images that benefit from a point of view that is removed from the user beyond the user's reach. Advantages of one or more embodiments of the device include low cost, in some cases through the use of an optical trigger rather than more complex radio frequency (e.g., Bluetooth) transmission. Other advantages can include portability as a result of the device being integrated into a writing device, which is more compact than a smartphone.

In some examples, the device also includes components for one or more of digitally capturing hand writings, receiving voice commands, receiving voice for a phone call, reproducing voice with a miniature loud speaker, reproducing notifications of phone calls, text messages and reminder. In some examples, the device includes circuitry (e.g., a transmitter) for wirelessly connecting to a digital computing device (e.g., a laptop, smartphone, etc.).

Other advantages can include portability as a result of the device being integrated into a writing device, which is more compact than a smartphone.

Other advantages can include a convenience of rapid, instantaneous collection of all the notes on distributed on various sources such as notebooks, sheets of paper, napkins, smartphone, into a single storage.

Other advantages can include a convenience of rapid, instantaneous sharing of hand written and voice recorded notes in a real time with digital devices used by other people.

Other advantages can include allowing more straightforward access to certain functions of a digital computing device, by replacing a necessity of activating the phone and finding of a certain app by a simple, intuitive, short command. Such a straightforward access decreases a cost of switching from task to task for overload professionals routinely involved into business communication and planning, allows for shorter on-the-spot reaction to important events. It also allows them access to important notifications on the occasions, such as business meetings, where smartphone is not allowed.

In another aspect, in general, a device has a proximal section having a writing implement and a trigger. A distal section of the device has a camera and a trigger receiver coupled to the camera. The proximal section and the distal section are coupled by a hollow telescopic section coupling. This telescopic section allows transmission of a trigger signal from the trigger to the trigger receiver inside the telescopic section.

Aspects can include one or more of the following features.

The trigger comprises a push button on a surface of the proximal section.

The trigger comprises an optical transmitter, and the trigger receiver comprises an optical receiver. In some examples, the optical transmitter comprises a light emitting diode (LED). In some examples, the optical receiver comprises a digital luminescence sensor.

The distal section is pivotably coupled to the telescoping section. In some examples, the distal section is coupled to the telescoping section through a hinge portion.

The distal section further comprises a mirror. In yet another aspect of the invention, the distal section further comprises a mirror covered by a cover plate that rotates between a closed position and an open position.

The distal section comprises a mirror covered by a cover plate, and is in the open position when the plate is rotated away from the mirror.

The mirror is oriented at a position that is angled to the camera.

The mirror is oriented relative to the camera such that when the distal section is in a position angled to the proximal end when viewed from the proximal end and the mirror substantially shows the image to be photographed.

The proximal section includes a sensor (e.g., orientation sensor, one or more axis accelerometer, etc.) built in to measure movements of the writing component of the pen.

The device embodies “smart pen” or “digital pen” functionality, for example, using the orientation sensor or accelerometer to measure movement of the pen and to transmit raw or processed measurements to a computing device. In some examples, these measurements are sent in “real-time” (e.g., as a stream and/or with low delay), permitting graphical feedback of what the user writes, for example, displayed on a computing device screen.

The distal section comprises a data processing and storage unit coupled to the camera.

The distal section further comprises a data connector for transferring images from the processing and storage unit.

The distal section further comprises a data transceiver to transfer images from the data processing and storage unit wirelessly.

The device further comprises an autonomous secondary power source. In a certain aspect, the autonomous secondary power source is located in the proximal section of the device.

Other features and advantages of the invention are apparent from the following description, and from the claims.

### DESCRIPTION OF DRAWINGS

FIGS. 1A and 1B show the device in the closed (A) and open (B) position.

FIGS. 2A and 2B show the distal section of an embodiment of the device where the mirror is covered by a cover plate (A) or exposed (B).

FIGS. 3A-3B show cross-sections of the device, corresponding to FIGS. 1A-1B, respectively.

### DESCRIPTION

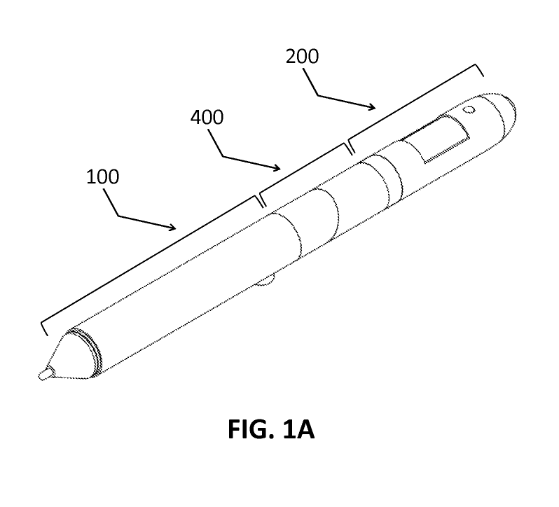

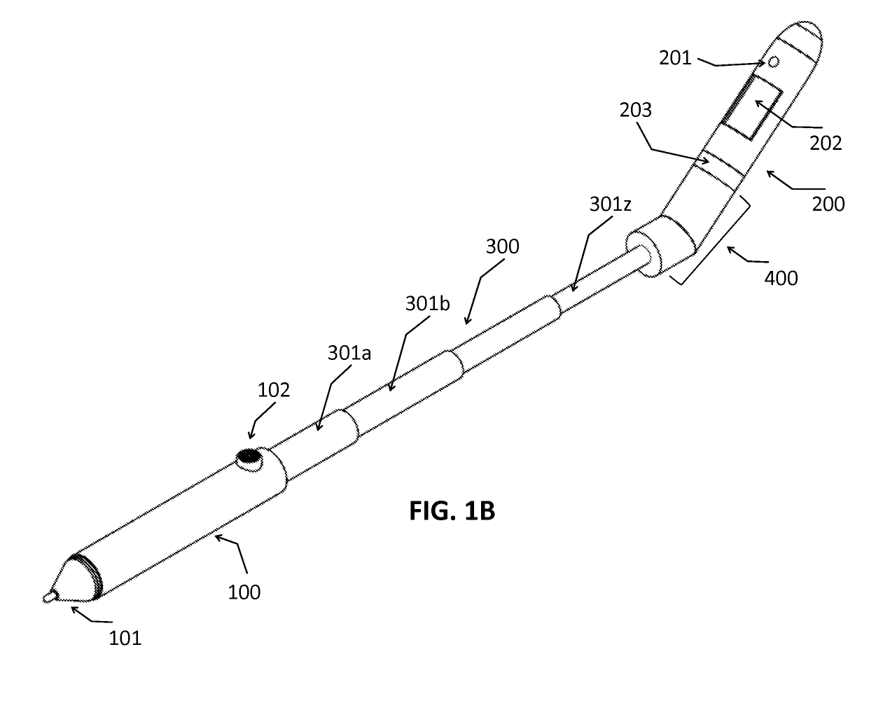

Referring to FIGS. 1A-1B, a device 10 functions as a writing device in a first configuration and functions as a “selfie” camera in a second configuration. This embodiment provides a low cost, light weight, small size device that a user can have available without the need for use of an expensive smartphone or camera. The device can be made inexpensive enough to be sold as a novelty item, or used as promotional material (“schwag”). While the description below focuses on the device being a pen, it should be understood that the writing device may be another form of writing instrument, such as a mechanical pencil or a stylus, and in some embodiments is not necessarily a writing instrument at all, such as a lecture pointer, a laser pointer, or miniature flag staff.

FIGS. 1A and 1B show the device 10 in a retracted (FIG. 1B) and an extended (FIG. 1A) configuration. Generally, the device comprises a proximal section 100, a distal section 200 and a telescoping section 300 that couples the proximal and distal sections. Referring to FIGS. 1A-1B, the proximal section 100 houses a writing implement 101, such as a pen (e.g., a ball point or fountain pen) or a mechanical pencil. The proximal section 100 also serves to house the telescopic section 300, which includes sections 301a-z, of the device when the telescopic section is retracted. The distal section 200 houses a camera 201. In FIGS. 1A-1B, the lens of the camera 201 is shown exposed on the surface of the distal section, with the mechanism of the camera (e.g., sensor, electronics, power supply, etc.) being housed within the distal section.

One feature of the embodiment is that the viewing direction of the camera 201 is adjustable so that when the device shown in FIG. 1A is held by a user at the proximal section 100, the camera 201 can easily be pointed back toward the user. As illustrated in FIG. 1A, in this embodiment, as discussed further below, this pointing toward the user is generally accomplished by the distal section 200 being mechanically adjustable to change its orientation relative to the telescopic section 300.

Continuing to refer to FIG. 1A, also contained in the proximal section is a trigger 102, for example, with a push button (or other sensor responsive to pressure from or the presence of the user's finger at the trigger) that is used by the user to signal to the camera 201 to capture an image (or in the case of video, to capture a series of video frames).

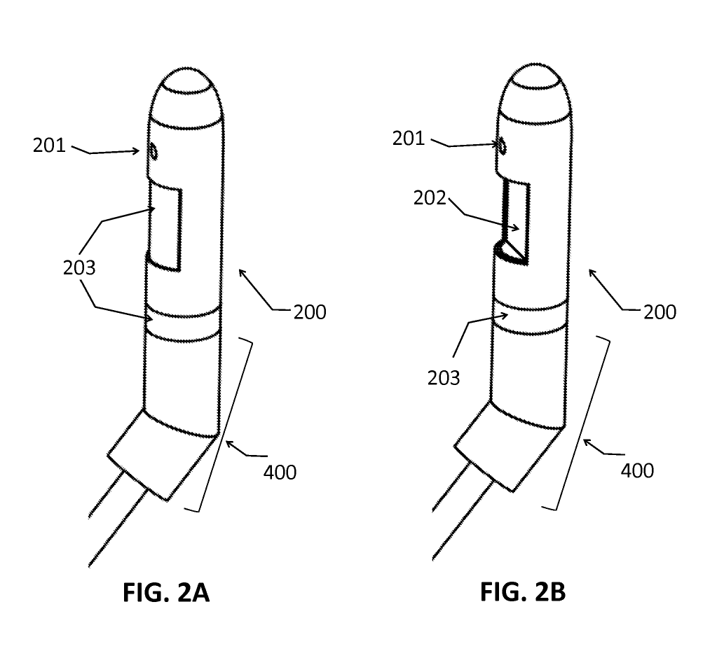

FIGS. 2A-B show an expanded view of the distal section 200 of the device. As introduced above, the distal section 200 is mechanically adjustable to change the orientation of the camera 201 relative to the telescopic section. In this embodiment, this adjustability is accomplished by use of a hinge 400. It should be understood that other mechanical arrangements other than a hinge can be used, for example, a flexible “gooseneck” or other flexible coupling can be used. In some embodiments, the hinge provides a stable position (e.g., at 60 or 90 degrees relative to the direction of the telescopic section) while in other embodiments, the hinge remains stable at any of a range of angles set by the user.

In order for the user to know whether orientation of the camera captures the desired field of view, this embodiment does not necessarily provide an electronic “view finder” or “preview” of the image that will be acquired. Rather, an optical arrangement is used so that the user has a visual reference of the field of view of the camera. This optical arrangement uses a mirror 202. Referring to FIG. 2B, the mirror 202 is arranged to be on an axis that is angled to the viewing direction of the camera 201. Therefore, when the user can see his or her face (i.e., can see his eyes) in the mirror, then the direction of view of the camera is directly toward the user. Because “selfie” images generally have the user taking the image in the center of the image, this mirror arrangement provides verification to the user when this is the case.

Continuing to refer to FIGS. 2A-B, the mirror 202 is not necessarily exposed in all configurations of the device. For example, it may not be desirable to have the mirror exposed when the device is used as a writing instrument (e.g., as shown in FIG. 1B). In this embodiment, the distal section 200 has a retractable cover 203 that uncovers the mirror 202 when the mirror is used to orient the camera, and is closed when the device is not being used as a camera. In the embodiment shown in FIGS. 2A-2B, the cover 202 is hinged, and is manually opened by the user prior to capturing an image. Note that in other embodiments, the cover can use other mechanical arrangements, for example, having the cover slide to expose the mirror. For example, the cover could slide along the long axis of the distal section, or could rotate around that axis. In yet other embodiments, no cover is necessary with the mirror being hidden by the proximal section when the telescopic section is retracted. In the embodiment shown, the cover is manually opened by the user, but is should be understood that in some embodiments, the cover is opened as a result of the distal section being pivoted.

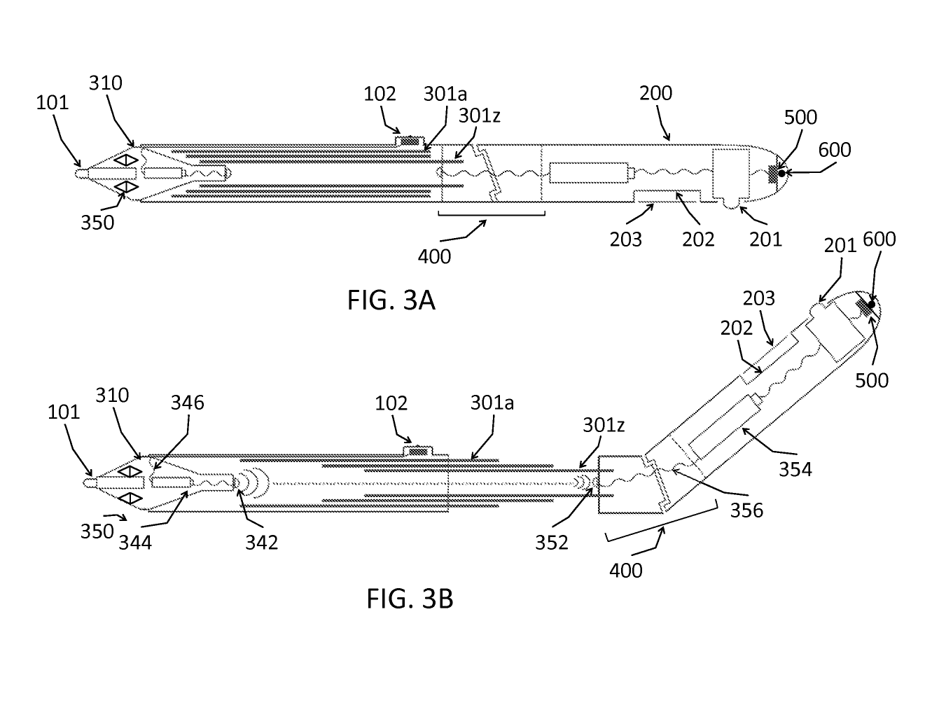

As introduced above, the proximal section includes a trigger 102, which is manually used by the user to trigger the camera to capture an image. Rather than using relatively expensive radio-frequency electronics for the trigger mechanism, this embodiment of the device uses an optical arrangement. FIGS. 3A-B show cross sections corresponding to FIGS. 1A-B respectively, and show aspects of the trigger mechanism. Referring to FIG. 1B, in the retracted configuration, a number of sections 301a-z of the telescopic section (here illustrated as two sections 301a and 301z, recognizing that in general there are more than two sections) are housed within the proximal section 100. The proximal section also includes a central section 310, situated within the telescopic sections 301a-z. This central section 310 includes the writing implement.

Continuing to refer to FIGS. 3A-B, the trigger 102 is electrically connected to a battery 344 (e.g., via a wire 346) and an optical transmitter 342 (e.g., a light emitting diode, LED). When the user activates the trigger 102, the optical transmitter sends out an optical signal (e.g., infra-red or visible light) that passes with the hollow central part of the telescopic section 300.

The distal section 200 includes an optical receiver 352 (e.g., a photodiode or other light-sensitive device) that is coupled to a battery 354 and the camera 201. When the optical receiver 352 senses the optical signal that is emitted from the optical transmitter 342, the camera's electronics capture the image.

Referring to FIGS. 3A-B, the camera 201 includes internal processing and storage for the digital image it captures, although in some embodiments this processing and storage is external to the camera. In the embodiment that is illustrated, the camera is coupled to a data connector 500, such as a microUSB output. A device (e.g., a smartphone, laptop computer, etc) can be coupled to the connector and images acquired by the camera are transferred through the connector. In alternative embodiments, other ways of transferring the image data can be used, including but not limited to use of Bluetooth, WiFi, or other radio frequency signals, or use of a removable processing and storage device (e.g., flash memory) that can be removed from the device 10 and read, for example, by the user's laptop computer.

Continuing to refer to FIGS. 3A-B, the distal section includes an indicating unit 600 implemented as an LED, LED array or a small size digital screen.

In the described embodiment, the device includes two batteries (e.g., removable and/or rechargeable batteries), one in the proximal section and one in the distal section. It should be understood that alternative embodiments may not require both batteries. For example, the optical transmitter may be powered by mechanical energy (e.g., a piezo-electric source coupled to the trigger, or electrical energy stored as a result of extending the telescopic section).

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

In some embodiments, the device includes a “smart pen” or “digital pen” functionality, instead of or in addition to physical pen functionality (i.e., for marking paper). One way of implementing the smart pen functionality is to embed an orientation or an accelerometer (e.g., a three-axis linear accelerometer) in the proximal end of the device. In some examples, the sensor is used to infer the trajectory of the “writing” tip of the device (e.g., the writing or stylus tip), and the raw measurements or inferred trajectory is passed to a computing device, for example, via a wireless link in “real time”. The computing device then processes the received information, for example, to store or display the user's writing. In some examples, the smart pen input is stored in association with images captured in the device.

In some embodiments, the device includes audio input/output components. For example, these components are used to communicate audio with a smartphone over a wireless (e.g., Bluetooth) link allowing the user to conduct a telephone call.

In some embodiments, the device includes graphical output components, for example, an LCD display. For example, the graphical output provides text message notifications to the user.

It is further to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A device comprising:
a proximal section having a writing implement and a trigger;
a distal section having a camera and a trigger receiver coupled to the camera; and
a hollow telescopic section coupling the proximal section and the distal section, and configured to allow transmission of a trigger signal from the trigger to the trigger receiver inside the telescopic section.

2. The device of claim 1, wherein the trigger comprises a push button on a surface of the proximal section.

3. The device of claim 1, wherein the trigger comprises an optical transmitter, and the trigger receiver comprises an optical receiver.

4. The device of claim 3, wherein the optical transmitter comprises a light emitting diode (LED).

5. The device of claim 3, wherein the optical receiver comprises a digital luminescence sensor.

6. The device of claim 1, wherein the distal section is pivotably coupled to the telescoping section.

7. The device of claim 1, wherein the distal section is coupled to the telescoping section through a hinge portion.

8. The device of claim 1, wherein the distal section further comprises a mirror.

9. The device of claim 1, wherein the distal section further comprises a mirror covered by a cover plate that rotates between a closed position and an open position.

10. The device of claim 1, wherein the distal section further comprises a mirror covered by a plate, and is in the open position when the plate is rotated away from the mirror.

11. The device of claim 10, wherein the mirror is oriented at a position that is perpendicular to the camera.

12. The device of claim 10, wherein the mirror is oriented relative to the camera such that when the distal section is in a position angled to the proximal end when viewed from the proximal end substantially shows the image to be photographed.

13. The device of claim 1, wherein the distal section comprises a data processing and storage unit coupled to the camera.

14. The device of claim 13, further comprising a data connector for transferring data, including image data, from the processing and storage unit.

15. The device of claim 13, further comprising an autonomous secondary power source.

16. The device of claim 15, wherein the autonomous secondary power source is located in the proximal section of the device.

17. The device of claim 16, wherein the proximal section comprises a motion sensor wherein the motion sensor is configured to provide a signal related to motion of a tip of the device

18. The device of claim 17, wherein the sensor is coupled to the optical transmitter in the proximal part for transmission of the signal from the sensor to the optical receiver is the distant part and to the processing and storage unit.

19. The device of claim 18, whereas the data processing and storage unit is configured to convert the sensor signal into an image representing writing.

20. The device of claim 19, whereas the data processing and storage unit is further configured to store the image.

21. The device of claim 20, further comprising a data transceiver configured to connect to an external mobile computing device and transfer data, including image data and motion data, from the data processing and storage unit.

22. The device of claim 21, further comprising a data transceiver capable configured to receive data from an external mobile computing device, said data comprising at least on of device state control data, a notification of a message, a calendar alert, and a reminder, generated by the mobile computing device.
